(19) United States
(12) Patent Application Publication
(10) Pub. No.: US 2010/0094615 A1
(43) Pub. Date: Apr. 15, 2010

(54) DOCUMENT TRANSLATION APPARATUS AND METHOD

(75) Inventors: Yoon Hyung Roh, Daejeon (KR); Sung Kwon Choi, Daejeon (KR); Ki Young Lee, Daejeon (KR); Oh Woog Kwon, Daejeon (KR); Young Kil Kim, Daejeon (KR); Cheng Hyun Kim, Daejeon (KR); Younge Ae Seo, Daejeon (KR); Seong Il Yang, Daejeon (KR); Yun Jin, Daejeon (KR); Eun Jin Park, Daejeon (KR); Ying Shun Wu, Daejeon (KR); Changhao Yin, Daejeon (KR); Sang Kyu Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/484,550

(22) Filed: Jun. 15, 2009

(30) Foreign Application Priority Data
Oct. 13, 2008 (KR) 10-2008-0099995

(51) Int. Cl. G06F 17/28

(52) U.S. Cl. 704/2

(57) ABSTRACT

A document translation apparatus includes a document processing module for analyzing associative relations between nouns or noun phrases within an input document to be translated to generate analysis information on texts; and a document translation module for selecting target words for the respective texts in reference to the text analysis information to generate morphemes corresponding to the target words, thereby producing a translated document corresponding to the input document.

### CROSS-REFERENCE(S) TO RELATED APPLICATION(S)

The present invention claims priority of Korean Patent Application No. 10-2008-0099995, filed on Oct. 13, 2008, which is incorporated herein by reference.

### FIELD OF THE INVENTION

The present invention relates to a document translation apparatus and method, and more particularly, to a document translation apparatus and method suitable for translating a language into another language through text analysis.

### BACKGROUND OF THE INVENTION

As well known in the art, in performing automatic translation, the selection of target words is an important factor in determining the quality of a final translation document. For this reason, many studies are going on for selecting accurate and natural target words.

These studies are about a technique for analyzing semantic ambiguity of words in terms of a source language, a technique for selecting natural target words in terms of an target language, and the like. To this end, co-occurrence information, selectional restriction pattern information, statistical information extracted from a massive target language corpus and the like have been used.

The conventional studies construct co-occurrence information, selectional restriction pattern information, target word selection information in the massive target language corpus in advance, and apply them to sentence translation. Hence, when translation is carried out on a document basis, information of a given document itself is not sufficiently used. In particular, in case of translation of Web documents, it is difficult to cope with appearance of new proper nouns, coined words, and the like.

Moreover, in case of English-Korean translation, an English document tends to avoid repetitive expressions, but a Korean document is likely to use the same expression for the same object. That is, translation is not carried out to reflect linguistic characteristics. For this reason, although the performance of translation is improved, an inaccurate and unnatural target sentence is generated, which results in a difficulty to understand a translated sentence.

### SUMMARY OF THE INVENTION

In view of the above, the present invention provides a document translation apparatus and method capable of improving performance of selecting target words through text analysis of an document to be translated, thereby obtaining a translation of the document.

Further, the present invention provides a document translation apparatus and method capable of recognizing proper nouns, collocations, and reference terms through text analysis, and selecting corresponding target words.

In accordance with one aspect of the present invention, there is provided a document translation apparatus including:

a document processing module for analyzing associative relations between nouns or noun phrases within an input document to be translated to generate analysis information on the texts; and

a document translation module for selecting target words for the respective texts in reference to the text analysis information to generate morphemes corresponding to the target words, thereby producing a translated document corresponding to the input document.

In accordance with another aspect of the present invention, there is provided a document translation method including:

analyzing morphemes of texts within an input document to be translated to perform morphological tagging; analyzing associative relations between nouns or noun phrases within the input document to generate text analysis information;

analyzing structures of source sentences in the input document with the adjusted tagging information, on the basis of the text analysis information;

transferring the structures of source sentences into structures of target language sentences; and

selecting target words for the respective texts within the structure-transferred sentences in reference to the text analysis information to generate morphemes corresponding to the target words, thereby producing a translated document corresponding to the input document.

### BRIEF DESCRIPTION OF THE DRAWINGS

The above and other features of the present invention will become apparent from the following description of an embodiment given in conjunction with the accompanying drawings, in which:

FIG. 1 is a block diagram of a document translation apparatus in accordance with an embodiment of the present invention;

FIG. 2 is a flowchart showing a process of performing tagging and translation for an English document based on text analysis to produce a translated document in accordance with an embodiment of the present invention;

FIGS. 3A to 3D are examples for explaining analysis of associative relations between nouns or noun phrases based on tagging information and statistical information about an English document to be translated in accordance with an embodiment of the present invention; and

FIG. 4 is a diagram illustrating effects resulting from translation which uses text analysis information in accordance with an embodiment of the present invention.

### DETAILED DESCRIPTION OF THE EMBODIMENTS

Hereinafter, embodiments of the present invention will be described in detail with reference to the accompanying drawings.

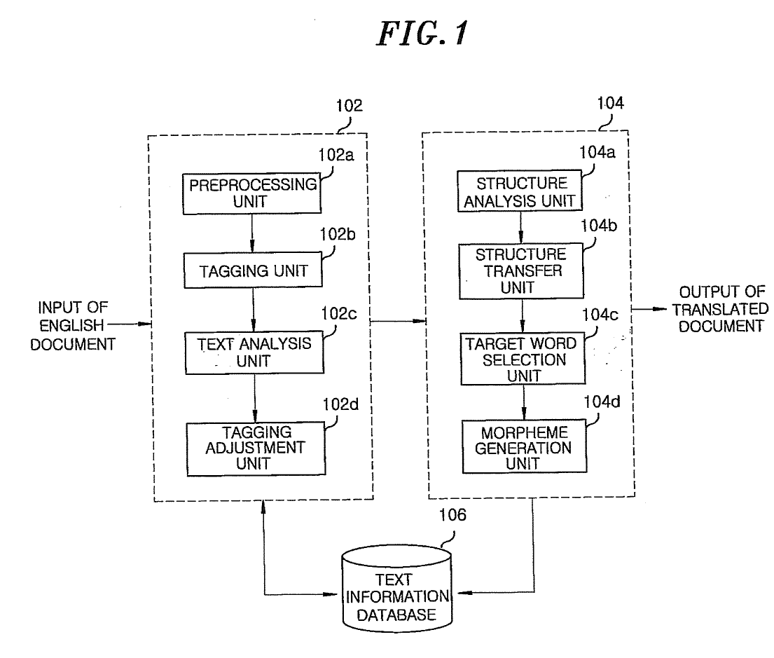

FIG. 1 is a block diagram of a document translation apparatus in accordance with an embodiment of the present invention. The document translation apparatus includes a document processing module 102, a document translation module 104, and a text information database 106. The document processing module 102 includes a preprocessing unit 102a, a tagging unit 102b, a text analysis unit 102c, and a tagging adjustment unit 102d. The document translation module 104 includes a structure analysis unit 104a, a structure transfer unit 104b, a target word selection unit 104c, and a morpheme generation unit 104d.

Referring to FIG. 1, the document processing module 102 performs a pre-tagging processing to recognize numerals, dates, and the like in a document to be translated, for example, an English document, analyzes morphemes within the English document to perform tagging on the basis of the analyzed morphemes, extracts statistical information on nouns from the tagged English document, and sorts the nouns by their frequencies. Further, the document processing module 102 analyzes associative relations between the nouns or noun phrases to generate text analysis information, corrects the tagging information on the basis of the generated text analysis information. The text analysis information is added to the tagging information and is then provided to the document translation module 104.

More specifically, the preprocessing unit 102a of the document processing module 102 recognizes numerals, dates, and the like among texts included in the English document, and chunks them separately in a single unit. The English document is then provided to the tagging unit 102b. As for the dates, texts written in various forms of, e.g. ‘2008, 06, 05’, ‘JUNE 05, 2008’, and the like may be differentiated and recognized.

The tagging unit 102b analyzes morphemes of the texts in the English document provided from the preprocessing unit 102a, performs morphological tagging, and transmits the tagged English document to the text analysis unit 102c.

The text analysis unit 102c extracts statistical information (for example, occurrence frequency and the like) on nouns from the tagged English document, and sorts the nouns, by their occurrence frequencies. The text analysis unit 102c further analyzes associative relations (for example, relations of synonym, analogue, hypernym, hyponym, and the like) between the nouns or the noun phrases to generate text analysis information. The text analysis information is then provided along with the tagged English document to the tagging adjustment unit 102d. In this case, sorting the words by the occurrence frequency is performed because words having a high occurrence frequency are more likely to have relation to the subject of the English document. Further, in the text analysis unit 102c, proper nouns are recognized by finding predetermined patterns, array of words starting with a capital letter and the like, and the noun phrases are extracted using base noun phrase chunking. The text analysis unit 102C also analyzes associative relations between the nouns or the noun phrases extracted from the English document by using the text information database 106, which stores English thesauruses such as WordNet, and analyzes connection relations between the latest analogues by using a stack, in which the nouns or the noun phrases are stored in recognized order.

The tagging adjustment unit 102d corrects the tagging information based on the text analysis information for the tagged document and adds the text analysis information to the tagging information, thereby yielding its output, the English document whose tagging information is adjusted.

The document translation module 104 analyzes sentence structures based on the tagging information of the English document with the adjusted tagging information, and performs structure transfer of the English sentence into, for example, a Korean sentence. The document translation module 104 also selects target words corresponding to the texts in reference to the text analysis information, and generates morphemes corresponding to the Korean document using the selected target words to produce the Korean document corresponding to the English document.

More specifically, in the document translation module 104, the structure analysis unit 104a analyzes sentence structures using the associative relations (relations of synonym, analogue, hypernym, hyponym, and the like) between the nouns or the noun phrases based on the tagging information of the English document from the tagging adjustment unit 102d, and transmits the structure analysis result to the structure transfer unit 104b.

The structure transfer unit 104b performs structure transfer of the English sentence into Korean sentence based on the structure analysis result provided from the structure analysis unit 104a. The structure-transferred result is then provided to the target word selection unit 104c.

The target word selection unit 104c selects target words for the words included in structure-transferred result from the structure transfer unit 104b, using the text analysis information. The structure-transferred result is then provided along with the target words to the morpheme generation unit 104d.

The morpheme generation unit 104d generates the morphemes corresponding to the Korean sentence using the target words, thereby producing the Korean document.

The text information database 106 stores, for example, proper noun dictionary data, partial word matching information, English dictionary data, Korean dictionary data, English thesauruses, Korean thesauruses, and the like which are utilized by the document processing module 102 or the document translation module 104 as occasion demands.

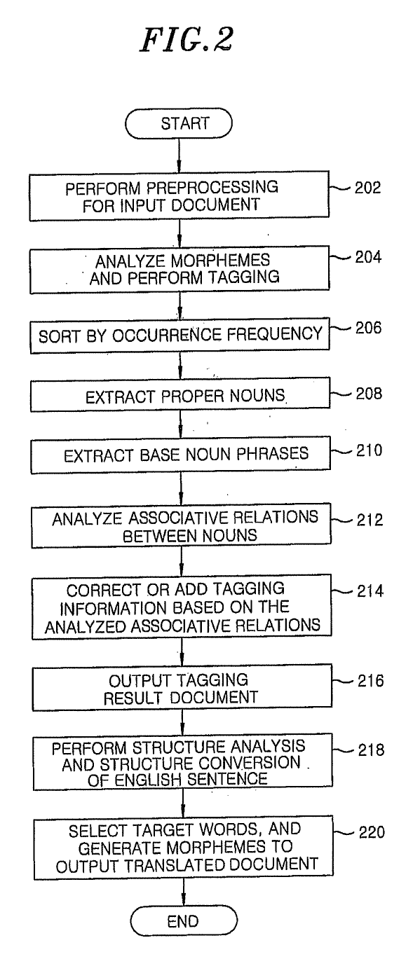

Next, the operation of the document translation apparatus having the above-described configuration will be described with reference to FIG. 2.

FIG. 2 is a flowchart showing a process of performing tagging and translation for an English document based on text analysis to produce a translated document in accordance with an embodiment of the present invention.

Referring to FIG. 2, in the preprocessing unit 102a of the document processing module 102, a pre-tagging processing is performed to recognize numerals, dates, and the like from among texts within the English document, and the preprocessed English document is provided to the tagging unit 102b in step 202. During the pre-tagging processing, for example, as for the dates, texts written in forms of ‘2008, 06, 05’, ‘JUNE 05, 2008’, and the like may be differentiated and recognized.

In the tagging unit 102b, morphemes of the texts in the English document is classified and analyzed, and tagging for the morphemes is performed. The tagged English document is then sent to the text analysis unit 102c in step 204.

Next, in the text analysis unit 102c, statistical information (for example, an occurrence frequency) is extracted as for nouns from the tagged English document and sorted by their occurrence frequencies in step 206.

Thereafter, in the text analysis unit 102c, proper nouns is extracted by finding predetermined patterns, array of words starting with a capital letter and the like in step 208, and base noun phrases are then extracted in step 210.

By the text analysis unit 102c, associative relations such as synonym, analogue, hypernym and hyponym are analyzed for the nouns or the base noun phrases in step 212. The text analysis information is then provided along with the tagged English document to the tagging adjustment unit 102d.

Subsequently, in the tagging adjustment unit 102d, the tagging information of the tagged English document is corrected depending on the text analysis information from the text analysis unit 102c and the text analysis information is added to the tagging information in step 214, and the English document with the adjusted tagging information is produced as in step 216.

After that, in step 218, structures of sentences of the tagged English document are analyzed by the structure analysis unit 104a using the associative relations such as synonym, analogy, hypernym and hyponym between the nouns and the noun phrase based on the tagging information of the tagged English document, and the structure analysis result is delivered to the structure transfer unit 104b. Structures of the tagged English sentences are transferred into structures of the Korean sentences in the structure transfer unit 104b on the basis of the structure analysis result. The structure-transferred sentences are passed to the target word selection unit 104c.

Next, in step 220, the target words are selected as for the nouns included in the structure-transferred English document provided from the structure transfer unit 104b, in reference to the text analysis information. The English document is provided to the morpheme generation unit 104d along with the target words. Subsequently, the morphemes corresponding to the Korean document are generated depending on the target words and thus a translated document, i.e. the Korean document is produced accordingly thereto.

In brief, preprocessing, tagging by the morpheme analysis, and sorting based on the statistical information are performed for the input document, and the document including the tagging information based on associative relations between the nouns or the noun phrases is outputted, and thereafter, structure analysis, structure transfer, selection of target word, and morpheme generation, for the outputted input document, are performed. In this way, a translation document corresponding to the input document can be produced.

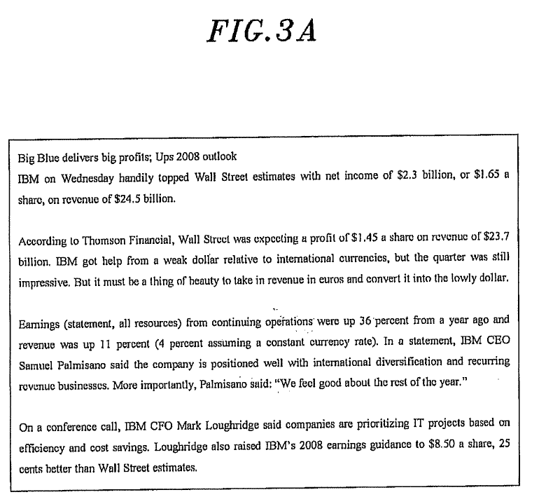

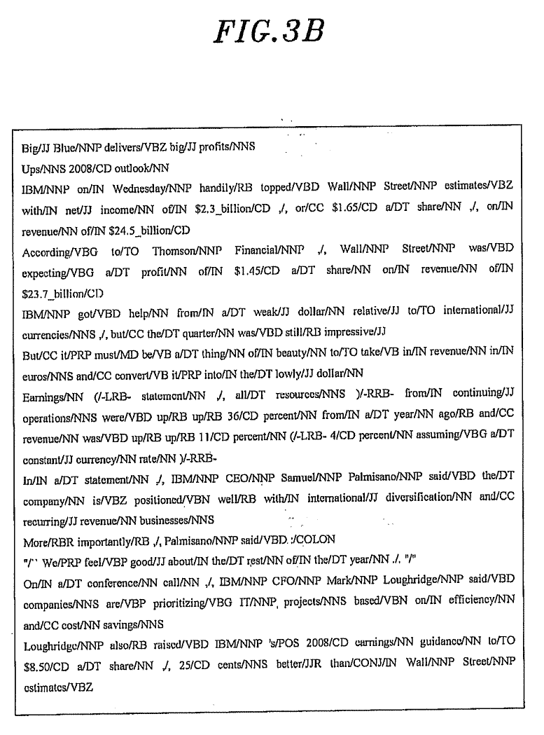

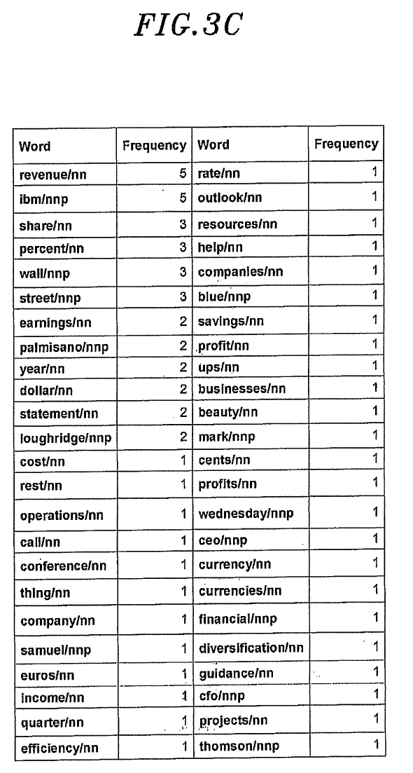

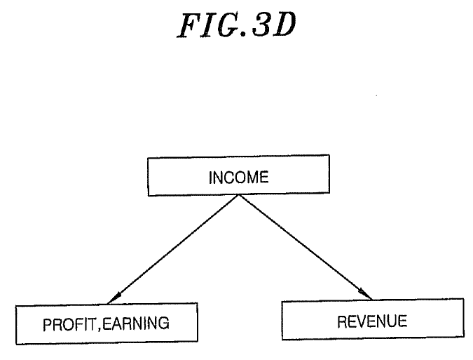

FIGS. 3A to 3D are examples for explaining analysis of associative relations between nouns and noun phrases based on tagging information and statistical information about an English document in accordance with the present invention.

When an English document shown in FIG. 3A is transmitted to the tagging unit 102b, the English document including a tagging result shown in FIG. 3B is then transmitted to the text analysis unit 102c. The text analysis unit 102c extracts occurrence frequencies of nouns (for example, with NN* tags), and sorts the nouns by their frequencies, as shown in FIG. 3C. The text analysis unit 102c further analyzes associative relations between the nouns as shown in FIG. 3D.

In FIG. 3B, the morphological tags include CC standing for a coordinate conjunction, CD for a numeral, DT for an article, EX for “there”, FW for a foreign language, IN for a preposition, JJ for an adjective, JJR for a comparative adjective, JJS for a superlative adjective, LS for a list item, MD for an auxiliary verb, NN for a noun, NNS for a plural noun, NNP for a proper noun, NNPS for a plural proper noun, PDT for a pre-determiner, PRP for a pronoun, PRP$ for a possessive pronoun, RB for an adverb, RBR for a comparative adverb, RBS for a superlative adverb, SYM for a symbol, TO for “to”, VB for a bare verb, VBD for a past-tense of verb, VBG for a progressive verb, VBN for a past participle, VBP for a present verb, VBZ for a third-person present verb, WDT for “which”, WP for a relative pronoun, WP$ for a possessive relative pronoun, WRB for a relative adverb, -LRB- for “(”, -RRB- for “)”, CONJ for a subordinate conjunction, CONJN for a conjunction “that”, and the like.

The text analysis unit 102c infers that a subject of the document relates to the “revenue” of the company “IBM”, based on the extracted information. Further, the text analysis unit 102c extracts proper nouns, such as “Big Blue”, “Thomson Financial”, “Wall Street”, “IBM”, “Samuel Palmisano”, “Palmisano”, “Mark Loughridge”, “IT”, “Loughridge”, and the like by using array of words starting with a capital letter and by using keywords, such as “CEO” and “CFO”. The text analysis unit 102c also extracts noun phrases, such as “big profits”, “Wall Street estimates”, “net income”, “international currencies”, “lowly dollar”, “all resources”, “continuing operations”, “constant currency rate”, “international diversification”, “recurring revenue businesses”, “conference call”, “IT projects”, “cost savings”, “earnings guidance”, and the like.

The text analysis unit 102c forms a list of associative relations by using the text information database 106, which stores proper noun dictionary data, partial word matching information, English dictionary data, Korean dictionary data, English thesauruses, Korean thesauruses, and the like. Here, the proper noun dictionary data is constructed by extracting proper nouns from a massive corpus, classifying a meaning of the proper nouns and adding target word information.

Meanwhile, the proper noun “Big Blue” has target words, such as “Conrail”, “IBM”, “Progressive Insurance”, and the like. There is established a relation of “Big Blue” being equal to “IBM” established through matching of the target words on the dictionary with the extracted words, and a relations of “Samuel Palmisano” being equal to “Palmisano” and “Mark Loughridge” being equal to “Loughridge” through partial word matching. With respect to the words except the proper nouns, words with semantic similarity are grouped by using a thesaurus, such as WordNet. When this happens, it can be seen that there are semantic subsumption relations of the words, as shown in FIG. 3D, from which analogues are recognized and the words' meanings are classified.

With respect to reference terms, when “NOUN” in a “the NOUN” form is a single noun, recognition of the reference terms is made by searching the latest analogues or collocations. In the example document, it can be seen that “the company” be “IBM”. Such all kinds of analysis information are transmitted to the tagging adjustment unit 102d. The tagging adjustment unit 120d corrects the tags for the proper nouns and stores collocation information in the tagging information for the utilization in a subsequent translation process.

Next, the target word selection unit 104c outputs “IBM” as a target word for “Big Blue” or “the company” on the basis of the collocation information and the reference term information. The word “Palmisano” or “Loughridge” can be seen to mean CEO or CFO from the collocations. Therefore, an appropriate verb phrase pattern can be selected and applied. Although the words “income”, “revenue”, “earning”, and “profit” are analogues, when they are translated into Korean, it may be necessary to differentiate target words from each other. The target words corresponding to the analogues of this case are differentiated and selected by constructing Korean differential dictionary data. If such differential dictionary data is not stored in the text information database 106, a single target word may be used for the analogues to maintain a consistency of translation.

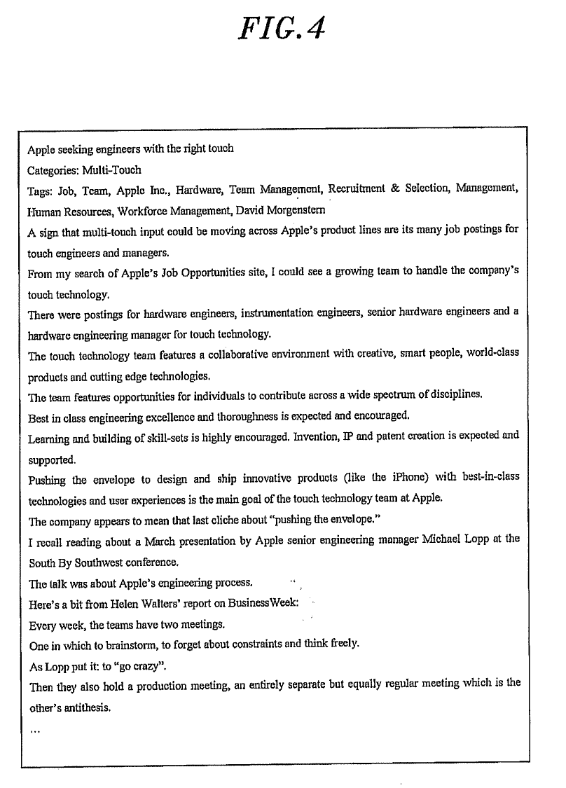

FIG. 4 is a diagram illustrating effects resulting from the translation which uses text analysis information in accordance with the present invention. After the process described with reference to FIGS. 3A to 3D, if analyzing the collocations and the reference terms, the analysis results are obtained such as “Apple”=“company”, “Michael Lopp”=“Lopp”, “touch technology team”=“team”, “the company”=“Apple”, and so on. According to the analysis results, the target word selection unit 104c can select target words as follows.

1. Apple seeking engineers with the right touch: If “Apple” was tagged as a common noun, its tag is corrected to a proper noun. And “Apple Company” is selected as a target word for “Apple”.

2. The team features opportunities for individuals to contribute across a wide spectrum of disciplines: A target word for “team” is substituted with a target word for “touch technology team”.

3. The company appears to mean that last cliche about “pushing the envelope.”: “company” is substituted with “Apple Company”.

4. As Lopp put it: to “go crazy”: “Lopp” can be substituted with “Michael Lopp” and can be recognized as a person's name due to semantic code of “Lopp”, and thus it can be used in structure analysis and pattern application.

Through the above-described process, accuracy and readability of a Korean translation corresponding to the English document can be improved.

In addition, the ability of recognizing proper nouns and selecting appropriate target words for collocations and reference terms can be improved by performing text analysis for a document to be translated, and extracting proper nouns, collocations, reference terms, and the like.

Although the present invention has been shown and described that an English document is translated into a Korean document, the present invention is not limited thereto. It should be noted that the present invention may also be applied to any other languages.

While the invention has been shown and described with respect to the embodiment, it will be understood by those skilled in the art that various changes and modifications may be made without departing from the scope of the invention as defined in the following claims.

What is claimed is:

1. A document translation apparatus comprising:
a document processing module for analyzing associative relations between nouns or noun phrases within an input document to be translated to generate analysis information on texts; and
a document translation module for selecting target words for the respective texts in reference to the text analysis information to generate morphemes corresponding to the target words, thereby producing a translated document corresponding to the input document.

2. The document translation apparatus of claim 1, wherein the document processing module includes:
a tagging unit for analyzing morphemes of the texts in the input document and performing morphological tagging; and
a text analysis unit for extracting statistical information about the nouns in the tagged input document, and providing the text analysis information, wherein the nouns are sorted by occurrence frequency of each noun.

3. The document translation apparatus of claim 2, wherein the document processing module further includes:
a preprocessing unit for performing a pre-tagging processing to recognize numerals and dates within the input document.

4. The document translation apparatus of claim 2, wherein the document processing module further includes:
a tagging adjustment unit for adjusting tagging information of the tagged input document on the basis of the text analysis information to output the input document with the adjusted tagging information.

5. The document translation apparatus of claim 2, wherein the text analysis information includes synonyms, analogues, hypernyms, and hyponyms with respect to the nouns or the noun phrases.

6. The document translation apparatus of claim 5, wherein the text analysis information is obtained by using proper noun dictionary data, partial word matching information, dictionary data for source language to be translated, dictionary data for target language, thesauruses for source language to be translated, and thesauruses for target language.

7. The document translation apparatus of claim 1, wherein the document translation module includes:
a structure analysis unit for analyzing structures of source sentences on the basis of the associative relations between the nouns or the noun phrases within the input document from the document processing module;
a structure transfer unit for transferring the structures of the source sentences into structures of target language sentences; a target word selection unit for selecting the target words for the respective texts in the structure-transferred sentences in reference to the text analysis information; and
a morpheme generation unit for generating the morphemes corresponding to the selected target words to produce the translated document corresponding to the input document.

8. The document translation apparatus of claim 7, wherein the target word selection unit selects the target words corresponding to the nouns and the noun phrases in the structure-transferred sentences using differential dictionary data, on the basis of the text analysis information.

9. A document translation method comprising:
analyzing morphemes of texts within an input document to be translated to perform morphological tagging;
analyzing associative relations between nouns or noun phrases within the input document to generate text analysis information;
analyzing structures of source sentences in the input document with the adjusted tagging information, on the basis of the text analysis information;
transferring the structures of the source sentences into structures of target language sentences; and
selecting target words for the respective texts within the structure-transferred sentences in reference to the text analysis information to generate morphemes corresponding to the target words, thereby producing a translated document corresponding to the input document.

10. The document translation method of claim 9, further comprising:
adjusting tagging information of the tagged document on the basis of the text analysis information to produce an input document having the adjusted tagging information.

11. The document translation method of claim 9, wherein said generating the text analysis information includes:
extracting statistical information about the nouns in the input document;
sorting the nouns in the input document by their occurrence frequencies; and
analyzing the associative relations between the nouns or the noun phrases to generate the text analysis information, wherein the associative relations include synonyms, analogues, hypernyms and hyponyms.

12. The document translation method of claim 11, wherein the text analysis information is obtained by using proper noun dictionary data, partial word matching information, English dictionary data, Korean dictionary data, English thesauruses, and Korean thesauruses.

13. The document translation method of claim 9, wherein said selecting the target words includes selecting the target words corresponding to the nouns and the noun phrases in the structure-transferred sentences using differential dictionary data, on the basis of the text analysis information.
